(19) United States
(12) Patent Application Publication
(10) Pub. No.: US 2012/0085176 A1
(43) Pub. Date: Apr. 12, 2012

(54) ANALOG STRAIN GAUGE CONDITIONING SYSTEM FOR SPACE ENVIRONMENT

(76) Inventors: Ray Morales, Houston, TX (US); Monty B. Carroll, League City, TX (US)

(21) Appl. No.: 12/899,654

(22) Filed: Oct. 7, 2010

(51) Int. Cl. G01B 7/16

(52) U.S. Cl. 73/773

(57) ABSTRACT

Provided herein are circuitry, a system and a method for conditioning an analog strain gauge signal in real time in the space environment. The circuitry and system provide means of modulating an excitation waveform input signal which in conjunction with a mechanical load applied to the analog strain gauge generate a modulated strain gauge output signal which is subsequently demodulated as the conditioned analog strain gauge signal. Using spread spectrum modulation on the sensor excitation waveform input signal allows operation without generating high levels of EMI. Subsequent demodulation of the sensor output signal in synchrony with amplitude modulating the sensor excitation waveform input signal provides a conditioned strain gauge signal that is a continuous representation of the load at the strain gauge in real time. Also provided is a method of monitoring a docking maneuver in a space environment.

### ORIGIN OF THE INVENTION

The invention described herein was made by employees of the United States Government and may be manufactured or used by or for the Government of the United States of America for governmental purposes without the payment of any royalties thereon or therefor.

### BACKGROUND OF THE INVENTION

1. Field of the Invention

This invention relates generally to the fields of electronics and docking technologies for spacecraft. Specifically, the present invention relates to analog circuitry to provide filtering to condition a strain gauge output signal for use in real time.

2. Description of the Related Art

Sensor measurements in the space environment are complicated by the hazards of that environment. For example, with a strain gauge load sensor located outside a spacecraft used to measure forces between two vehicles during a docking maneuver, prior to docking, there is a voltage potential between the two vehicles caused by the space plasma environment. On contact this potential is discharged with a fast rise time voltage transient. The voltage may be large depending on the docking conditions. The combination of fast rise time and high potential causes a large pulse to be sent through the vehicle structure. Due to their location in the docking system, the load cells are at risk of coupling this transient into their signal leads, resulting in either damage to the subsequent electronics or errors in the load cell readings.

Other hazards present in the space environment include electromagnetic interference (EMI) caused by nearby transmitters, DC offset voltages in the load cell lead wires and DC offset voltages due to spacecraft charging effects. Operational features, such as in place calibration of the load cell system to eliminate the effects of drift as the electronic components age, and low pass filtering of the signal, are also required. If the load cell is part of a closed loop control system the time delay between when a load is applied to the sensor and when the conditioned voltage appears at the output is another important requirement. It is preferred that in order to maintain the stability of the control loop the phase shift for the strain gauge signal conditioning system is kept to a minimum. This invention provides filtering with the phase response of a single pole filter.

The transient voltage requirement is a common specification in isolation circuits. However, most commercially available isolation circuits are not suitable if a higher level of protection is required. Most commercially available isolation circuits for strain gauge sensors are rated below 5 kV. In a space flight environment an effect called spacecraft charging can cause high voltages between docking vehicles which may be discharged upon contact of the two vehicles by a high transient voltage with a fast rise time. Depending on the vehicle size and location, the withstand voltage can be higher than the 5 kV currently available. Another high voltage threat is lightning. For example, during spacecraft ascent the vehicle can be struck by lightning. A lightning strike may cause large currents to he induced into vehicle wiring and if not protected, the associated electronics may be damaged. Depending on the location of the strike on the vehicle the voltage transients can be quite large and greater than the 5 kV currently available.

Spacecraft charging causes a second effect. Charge is induced into different components of the same vehicle resulting in differing DC potentials between adjacent parts of the spacecraft. High impedance circuits are vulnerable, including electrically isolated portions of the spacecraft itself, and can have varying levels of charge induced into them causing DC voltage offsets which affect electronic devices. Strain gauge sensors float relative to the ground level and can acquire a large common mode voltage in these circumstances. Even if the resultant voltage is not sufficient to damage the electronics, the voltage can interfere with the proper operation of the conditioning system.

With the load cell directly exposed to the space environment, EMI susceptibility is another concern. High levels of signal plus noise can saturate the input of an amplifier, or cause RF rectification errors. E field levels up to 250V/meter can be encountered across a wide frequency range. The low output voltage from the strain gauge, which is about 20 mV full scale with a typical 10 VDC excitation applied, means that small amounts of noise induced into the signal lines result in low signal to noise ratio and cause major errors in the load reading. A second effect occurs when allowing RF noise into the sensitive front end of a load cell amplifier. This can cause RF rectification of the high frequency noise resulting in internal DC offset voltages causing errors in the output reading. While the load cell sensing system may be protected from EMI it may also not radiate any EMI thereby protecting other electronic equipment aboard the vehicle. For systems which use AC excitation of the load cell, the radiated EMI may be attenuated by shielding and or modulation schemes that minimize or spread radiated energy.

The sensor and the lead in wire should be capable of long duration operation, e.g., several years, in the space environment of vacuum; typical high and low temperatures ranging from about +100° C. to about −100° C.; and high levels of ionizing radiation. In addition the lead in wire should be capable of being repeatedly flexed during operation. Because of these hazards it is not possible to co-locate the amplifier with the strain gauge load cell. Therefore solutions involving co-locating the amplifier with the sensor to improve the signal to noise ratio are not possible. It may be necessary to locate the electronic conditioning circuits in a remote location from the sensor and run cable between the load cell and the conditioning system.

Cables, connectors, and shielding materials, provide the required electrical conductivity, however they also include parasitic elements that cannot be eliminated from the cable. These elements are generally referred to as series resistance, shunt capacitance and series inductance. Depending on the excitation method and frequency, one or all of these can cause errors in the readings. The deleterious effects become more pronounced as the line length becomes longer and the excitation frequency increases. The conditioning system may be capable of removing these effects from the readings.

Used as a component of a closed loop control system, the signal conditioning of the load cell may provide low time delay. The time from when a load is applied to the load cell to when the conditioned output signal has stabilized determines the time delay the signal conditioner has added to the closed loop control operation. This time delay is also referred to as phase shift in the control loop. The stability of the control loop is dependent on the phase shift and may be kept to a minimum. For the load cell used in monitoring docking forces a phase shift of −45 degrees at the filter break frequency is the maximum that can be tolerated in the application, this is typical of many real time control systems. This corresponds to a single pole roll off characteristic. As a result many conditioning systems are not acceptable in this application because of their use of multipole filters, or of certain types of digital signal processing which adds too much delay time.

Any sensor or electronic system may vary over time resulting in errors that may be compensated out of the system. For a strain gauge, the most effective means is to install an in place shunt calibration scheme to allow periodic calibrations so that all drift and system gain errors can be removed prior to use. Of course the calibration scheme may experience all the same hazards as the sensor and may be designed to operate in that environment.

The simplest and most direct hookup of a load cell is an instrument amplifier. The lead wires from the load cell are connected directly to the input of an op-amp or instrumentation amplifier. DC excitation is applied to the load cell excitation input. This topology provides excellent results in normal circumstances and many excellent amplifiers are available to perform this function. However the circuit has no protection for the amplifier against incoming transient voltages, DC offset voltages or EMI. A large transient could damage the amplifier and then proceed to the circuits on the output side of the amplifier causing a system failure.

Zener diodes or transient protectors are often added to the above circuit to add transient voltage protection to the front end of the circuit. This circuit is better, however, it still cannot protect against DC voltages below the zener voltage present on the load cell lead wires. For DC common mode voltages above the zener voltage the output may saturate since the zener diode may clamp all voltages including the signal voltage to the zener voltage level. It also is susceptible to RF rectification errors when EMI is applied to the load cell lead wires. Because of the location of the zener on the load cell signal lines, the reverse leakage current through the zener may cause offset errors in the output reading. The amount of offset depends on the zener, ambient temperature, and the common mode voltage present across the zener. In some applications a small resistor is added in series with the signal line just before the zener diode to improve the attenuation of input transients. While this improves the input transient voltage performance of the circuit it compounds the other errors and further reduces the accuracy of the load reading. As in the circuit describe above, if a large transient were to damage the zener diode or the diode were to fail open the result would be that the input transient would appear at the output of the amplifier and potentially cause a system failure.

With the addition of an EMI filter to the front end of the circuit the incoming EMI can be reduced eliminating the threat from RF rectification. However, the circuit is still vulnerable to DC common mode voltages. A failure in this circuit could allow a transient to appear on the output of the amplifier causing a system failure.

A circuit utilizing optoisolated isolation amplifiers is comprised of an amplifier followed by a modulator which sends the amplified signal across an optoisolated barrier. This effectively prevents any transient less than the optoisolators-rated withstand voltage from reaching across the barrier. The primary to secondary capacitance may allow a portion of the input transient to pass but an additional filter can remove this. However the electrical components used to modulate the input signal are located on the sensor side of the barrier and are vulnerable to all the hazards listed above for the zener protected amplifier case. Also most optoisolators do not have the rated withstand voltage to meet the transient voltage requirement of the docking system application.

In these circuits a DC voltage is used for excitation of the load cell. As a result all of them suffer from a sensitivity to DC normal mode voltage. A method to negate these effects is to utilize AC excitation of the load cell. Using sinusoidal AC allows the sensor bandwidth, i.e., the baseband signal, to be translated to the carrier frequency which is the sinusoidal AC excitation waveform produced by the modulator. The modulated carrier signal may then be demodulated with a zero crossing detector or a synchronous demodulator using phase information from the modulator. Once the sensor signal is demodulated, a low pass filter is used to recover the original load cell signal, the recovered signal can then be amplified to the desired level.

This technique moves the baseband signal away from dc and eliminates any DC offsets from the measurements. It also is an effective means to remove noise from the signal. Such circuits are referred to as Lock-In amplifiers. While this circuit is effective at reducing noise up to the carrier frequency, the noise around and above the carrier frequency can cause large errors in the readings due to the aliasing effects of the demodulator. Noise of this frequency may be prevented from entering the demodulator through the use of shielding or other techniques to remove the noise without affecting the sensor signal.

Another difficulty with this circuit is determining when the zero crossing occurs. In circuits using zero crossing detectors the zero crossing detector can be prone to jitter caused by incoming noise. Even with synchronous demodulation, where phase information from the modulator is used to demodulate the input signal, the sinusoidal excitation may have difficulty determining the zero crossing because the phase changes with increasing line length due to lead wire parasitic elements. While some adjustments can be made to reduce this error the adjustment may be made for each load cell individually and may not compensate for changes in temperature or changes of the cable parasitic components over time.

While the noise performance of this circuit is much better than the previous circuits it still suffers from susceptibility to high input voltage transients and incoming noise at or above the carrier frequency. This circuit lacks the necessary input to output isolation and protection from high voltage transients. Also since the load cell excitation is now a modulated AC waveform radiated RF from the carrier may need to be reduced to acceptable levels. The use of spread spectrum techniques to reduce the radiated RF emissions of the excitation signal may only compound these problems because the varying frequencies of a spread spectrum spreading sequence may produce differing phase delays in the lead wire parasitic elements adding errors to the demodulation process.

Since the excitation is an AC waveform it can be isolated through the use of a series transformer. By applying such a transformer to the circuit above, the transformer isolated case with sinusoidal excitation is obtained. The transformer may provide the necessary input transient voltage performance and the input to output isolation. The circuit is however still susceptible to the other problems detailed above for the sinusoidal excitation case. In particular the problems with phase shift between the excitation waveforms and the synchronization with the demodulator are still present in this circuit and aliasing errors from noise above the carrier frequency are also still present. The use of spread spectrum techniques on the excitation signal in the above circuit may only compound the demodulation problems.

The problems mentioned above with sinusoidal excitation referring to phase shift between the excitation waveform and the incoming signal can be reduced through the use of a technique called dual phase detection where the input signal is routed to two demodulators. One demodulator acts as described above while the other acts on the incoming signal but the reference signal to the demodulator is phase shifted by 90 degrees. The vector combination of these two orthogonal outputs remains constant even if the input signal changes phase. Whether calculated by digital or analog means the time required to calculate the vector sum of these filter output voltages adds time delay to the overall filter response thus degrading the phase shift. While this technique may address the changing input phase shift problem, it adds considerable complexity to the design of the circuit and adds electrical components making the unit more costly and difficult to build and test.

Accordingly, a need in the art is present for a strain gauge conditioning system effective to protect against incoming transients, modulate AC excitation to the load cell, read the load cell, filter the resultant voltage, maintain a single pole phase shift, and provide in place calibration while operating in the space environment. More specifically, the prior art is deficient in circuitry that utilizes analog electrical components with a single pole roll off characteristic for monitoring and conditioning a strain gauge signal in real time in a space environment. The present invention fulfills this longstanding need and desire in the art.

### SUMMARY OF THE INVENTION

The present invention is directed to circuitry for conditioning an analog strain gauge output signal. In an embodiment, the circuitry comprises means for modulating an excitation waveform input signal, an analog strain gauge load cell electrically connected to receive an input signal and configured to produce a modulated output signal, a synchronous demodulator electrically connected to receive a modulated output signal and configured to produce a demodulated strain gauge output signal, a passive RC filter electrically connected to receive a synchronous demodulator output signal and configured to produce a conditioned strain gauge output signal, means for electrically isolating an input signal to or an output signal from an analog strain gauge load cell, and a control unit operably integrated within the circuitry. The present invention is directed to circuitry that further comprises a calibration shunt electrically connected between the analog strain gauge load cell and the control unit.

The present invention also is directed to a method for conditioning an analog strain gauge output signal in real time. In an embodiment, the method comprises sensing a load applied to an analog strain gauge load cell, modulating an excitation waveform input signal; and isolating the modulated excitation waveform input signal. In another embodiment, the method comprises sensing a load applied to an analog strain gauge load cell; modulating an excitation waveform input signal; isolating the modulated excitation waveform input signal; applying said isolated modulated excitation waveform signal to said strain gauge load cell; obtaining a modulated output signal that is a function of said isolated modulated excitation waveform and said applied load; isolating said modulated output signal; and demodulating the isolated modulated output signal in synchrony with modulating the excitation waveform input signal thereby conditioning the analog strain gauge output signal in real time. In another aspect to these embodiments the demodulating step may comprise synchronously rectifying the isolated modulated output signal to produce a rectified signal. In this aspect the synchronously rectifying step comprises alternately inverting the isolated modulated output signal in synchrony with the modulating step. In another aspect to these embodiments, the method embodiment may comprise filtering the rectified signal via a passive RC filter to produce the conditioned analog strain gauge signal. The modulated input signal is applied to the strain gauge load cell whereupon a modulated output signal that is a function of the isolated modulated excitation waveform and the applied load is obtained. The modulated output signal is further isolated and subsequently demodulated in synchrony with modulating the excitation waveform input signal thereby conditioning the analog strain gauge output signal in real time. The present invention is also directed to a method comprising a further step of calibrating the strain gauge load cell.

The present invention is directed further to an analog strain gauge conditioning system. In an embodiment, the conditioning system comprises a DC power supply, transformer driver circuits operably connected to the power supply, an analog strain gauge load cell operably connected to the driver circuits, an excitation transformer operably disposed between the driver circuits and the analog strain gauge load cell, a sense transformer, a control unit, a calibration shunt operably disposed between the analog strain gauge and the sense transformer, and means to operably connect individually the DC power supply, the transformer driver circuits, the synchronous demodulator, and the calibration shunt to the control unit.

The present invention is directed further still to a method of monitoring a docking maneuver in a space environment in real time. The method comprises sensing a load applied to the analog strain gauge load cell comprising the analog strain gauge conditioning system described herein during docking and conditioning the analog strain gauge signal via the conditioning system wherein the conditioned signal is a continuous representation of the strain gauge load during docking thereby monitoring the docking maneuver contact forces in real time.

Other and further aspects, features, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIG. 1 depicts a block diagram of the analog strain gauge conditioning system.

FIG. 2A depicts the system timing diagram for Mode 1 operation.

FIG. 2B depicts the system timing diagram for Mode 2 operation.

FIG. 3A depicts a schematic of the synchronous demodulator circuit.

FIG. 3B depicts a schematic of the RC passive filter circuit.

FIG. 4A depicts the frequency response for fixed frequency Mode 1 operation of the synchronous demodulator and low pass filter, for two different duty cycle values.

FIG. 4B depicts the phase response for fixed frequency Mode 1 operation of the synchronous demodulator and low pass filter, for two different duty cycle values.

FIG. 4C depicts the frequency response for Mode 2 fixed frequency operation of the synchronous demodulator and low pass filter, for two different duty cycle values.

FIG. 4D depicts the phase response for Mode 2 fixed frequency modulation operation of the synchronous demodulator and low pass filter, for two different duty cycle values.

FIG. 5 is reserved.

FIG. 6 is a graph used in the development of the equations for this invention. There are two plots illustrated on the graph. The first plot depicts the output voltage from the demodulator and RC filter as a unit step input is applied to the strain gauge load cell. The second plot is for reference and depicts the response of a continuous single pole low pass filter as a unit step input is applied to the strain gauge load cell, time constants are the same in both plots. The continuous curve represents the ideal desired response for this invention.

FIG. 7A depicts the frequency response for spread spectrum excitation using a pseudo random spreading sequence with amplitude modulation.

FIG. 7B depicts the phase response for spread spectrum excitation using a pseudo random spreading sequence with amplitude modulation.

### DETAILED DESCRIPTION OF THE INVENTION

In one embodiment of the present invention there is provided circuitry for conditioning an analog strain gauge output signal, comprising means for modulating an excitation waveform input signal; an analog strain gauge load cell electrically connected to receive an input signal and configured to produce a modulated output signal; a synchronous demodulator electrically connected to receive a modulated output signal and configured to produce a demodulated output signal, a passive RC filter electrically connected to receive a demodulated output signal and configured to produce a conditioned strain gauge output signal; means for electrically isolating an input signal to or an output signal from an analog strain gauge load cell; and a control unit operably integrated within said circuitry. In this embodiment the output strain gauge signal is a function of an excitation waveform signal and a load applied to the strain gauge load cell.

In another embodiment, the circuitry further comprises a calibration shunt electrically connected between said analog strain gauge load cell and the control unit. In a further embodiment, the calibration shunt comprises a resistor electrically connected to the output of the analog strain gauge load cell; a relay configured to switch the resistor into and out of the circuitry, wherein the relay is operably connected to the control unit.

In an aspect to these embodiments means for modulating an excitation waveform input signal comprises a DC power supply, transformer driver circuits electrically connected to the power supply, wherein the power supply and the transformer driver circuits are operably connected to the control unit. Further to this aspect, the means for modulating an excitation waveform may comprise spread spectrum modulation techniques.

In another aspect the synchronous rectifier may comprise four analog switches configured to rectify the modulated output signal in synchrony with modulating the excitation waveform input signal.

In another aspect of these embodiments the passive RC filter comprises a single pole low pass filter.

In yet another aspect there is provided a means for electrically isolating an input signal to or an output signal from the strain gauge load cell comprising an excitation transformer electrically connected between the means for modulating an excitation waveform signal and the strain gauge load cell; and a sense transformer electrically connected between the strain gauge load cell and the synchronous demodulator. In these aspects means for electrically isolating an input signal to or an output signal from the strain gauge load cell may include isolating other input to output galvanic currents. In an aspect to these embodiments the means for electrically isolating or the step of isolating described in a method embodiment above may include isolating, filtering out or a combination thereof of other input-to-output galvanic currents via an excitation transformer and a sense transformer

In another aspect to these embodiments the calibration shunt may comprise a resistor operably connected to the analog strain gauge load cell and a relay operably disposed between the resistor and the control unit.

In all aspects of these embodiments the strain gauge load cell may be physically mounted in a space environment such that the modulating and demodulating steps are performed in a location remote from and protected from the space environment. Also in all aspects the isolating steps are performed at an interface between the space environment and the remote location. Furthermore, in all aspects the applied load may be generated between two vehicles during a docking maneuver in the space environment.

In still another embodiment of the present invention there is provided a method of monitoring a docking maneuver in a space environment in real time, comprising sensing a load applied to the analog strain gauge load cell comprising the analog strain gauge conditioning system described supra during docking; and conditioning the analog strain gauge signal via the conditioning system wherein the conditioned signal is a continuous representation of the strain gauge load during docking thereby monitoring the docking maneuver in real time. In this embodiment the strain gauge load cell is physically mounted in the space environment and the excitation and sense transformers independently are interfaced with the space environment and a location protected from the space environment suitable for conditioning the analog strain gauge signal.

As used herein, the term, “a” or “an” may mean one or more. As used herein in the claim(s), when used in conjunction with the word “comprising”, the words “a” or “an” may mean one or more than one. As used herein “another” or “other” may mean at least a second or more of the same or different claim element or components thereof.

Provided herein is an analog strain gauge conditioning system that is highly effective in a space environment. This conditioning system provides protection against space environment hazards such as, inter alfa, high voltage fast rise time transients, high common mode voltages, the EMI environment, and long signal leads. The system is composed of only analog components thus avoiding the complexity and cost of digital signal processing methods. The conditioning system avoids the use of dual phase detection, which adds complexity and cost to the design. Also, because there are fewer electrical components the circuit may have improved radiation hardness specifications.

The conditioning system utilizes square wave excitation of a load cell and windowing the input signal, also known as (aka) Vᵢₙ. Additionally, the conditioning system provides low emitted EMI due to the spread spectrum modulation of the load cell excitation waveform. Because an excitation and sense transformer is used for isolation, the load cell signal may be modulated on a carrier frequency to pass through the transformer. In related art, the carrier waveforms for the strain gauge load cells are DC voltages or sinusoidal AC voltages. In direct contrast, this invention uses modulated positive and negative going square waves with dead time between the pulses. The excitation allows the synchronous demodulator to window the input signal in such a way that the strain gauge circuit stabilizes before applying the rectified signal to a continuous or passive RC filter. This technique removes the effect of parasitic elements on the strain gauge load cell lead wires yet provides the performance very close to that of a continuous, i.e. not sampled, filter. It also avoids the accuracy problems inherent in sinusoidal excitation schemes due to the inability to determine exactly when the carrier frequency zero crossing occurs.

The conditioning system is generally comprised of a combination of modulator, transformer isolators, a synchronous rectifier, and single pole filter adapted to work together to provide the required performance. The modulator, which generates the strain gauge excitation signal, changes amplitude and pulse width in concert with the demodulator operation to provide the voltage levels to the filter stage to maintain the single pole transfer function. This is necessary when using spread spectrum techniques on the excitation waveform because the constantly changing duty cycle of the spreading code may cause amplitude or frequency offsets to occur in the filter. This is accomplished by using an unusual configuration of demodulator operation and a modified low pass filter.

In an embodiment, the conditioning system displays only a single pole roll off characteristic for magnitude and phase shift, i.e., provides low input to output delay. By adjusting each excitation square pulse amplitude, the effects of transformer droop and demodulator duty cycle can be compensated out. This is notable in applications where the delay caused by filtering may cause problems, such as in a real time control environment.

Input to output galvanic isolation is provided by the excitation and sense transformers. Specifically, the excitation transformer provides isolation for the excitation circuits and the sense transformer provides isolation for the demodulator/amplifier circuits. The use of a transformer as the isolation element provides simple reliable protection from the high voltage fast rise time transients and high DC levels produced by spacecraft charging. Ground currents, noise currents, etc., cannot flow across the transformer. This lack of flow provides input to output isolation and it also assures that any transients or ground currents which occur on the sensor side of the transformer may not pass through to the subsequent electronic system, thus avoiding damage to those systems. This phenomenon is also referred to as input to output isolation.

Transformers are a mature technology and have been used for many years in high voltage applications. Any level of voltage protection can be designed into the filter by designing the transformer for operation at the required levels. Any coupling caused by the transformer's primary to secondary capacitance can easily be eliminated with a filter following the transformer. In addition to reduce this coupled transient, the primary to secondary capacitance can be reduced through the use of winding techniques and transformer shields to very low levels.

The conditioning system described herein provides circuit protection against high levels of common mode AC and DC input voltages. The conditioning system allows operation in high levels of EMI. Also, normal mode DC input offset voltages are removed. These offset voltages are usually caused by the resistance of the lead wires or by the thermoelectric effects in the cabling system. Furthermore, the conditioning system allows large parasitic components to exist on the load cell lead wires. Thus, long cables may be used without affecting the accuracy of the readings. As used herein, a “long” cable is defined as a cable length greater than or equal to 50 feet. The conditioning system can handle cables between 100-1000 feet without difficulty. Typical applications are in the range from about 1 foot to 50 feet. The strain gauge sensor can be mounted in the mechanical load path while the electronic signal conditioning can be located remotely in a protected environment.

Accordingly, a method of conditioning the output signal of a strain gauge load cell using the circuitry and systems described herein is provided. It is contemplated that a conditioned output signal is useful as part of real time strain gauge load sensing applications, such as, but not limited to, applications in a space environment, e.g., docking maneuvers. It is further contemplated that the circuitry, systems and methods described herein may have applications in the fields of instrument manufacturing or of strain gauge sensors using pressure, force or torque transducers.

Embodiments of the present invention are better illustrated with reference to the figures, however, such reference is not meant to limit the present invention in any fashion. The embodiments and variations described in detail herein are to be interpreted by the appended claims and equivalents thereof.

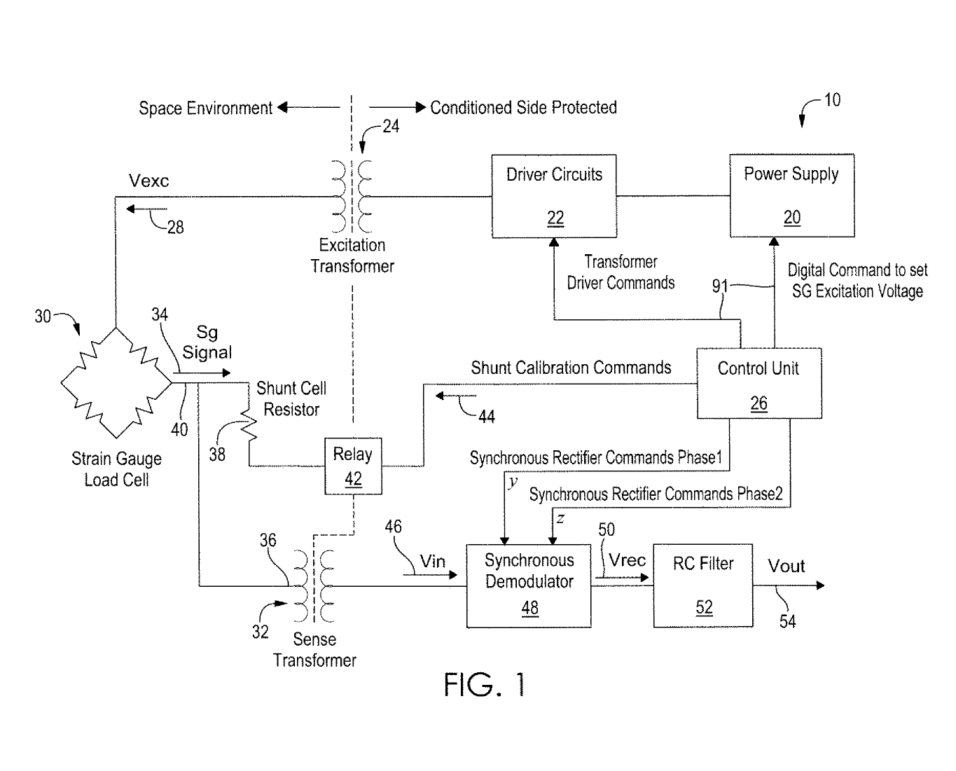

FIG. 1 is a block diagram of the analog strain gauge conditioning system 10. The power supply 20 and the driver circuits 22 provide the drive for the excitation transformer 24 and are digitally controlled by a control unit 26. The block diagram illustrates the case for spread spectrum where the amplitude may change in sync with the Tₒₙ time. The excitation transformer 24 is electrically connected to the driver circuits 22 wherein variable source voltage provides the necessary output excitation waveform V_{exc} 28. A spread spectrum modulation waveform may be used to meet the standards for radiated emissions. For those applications that do not require spread spectrum performance, a constant pulse width, i.e., fixed frequency, modulation scheme provides all the protection and performance benefits without the added parts and complexity of using spread spectrum techniques. For these applications an excitation transformer with constant excitation amplitude and duty cycle is all that is required.

In order to reduce the radiated EMI generated by the excitation waveform, the rise and fall times of the excitation waveform can be increased. Adjusting the rise and fall times may not affect the accuracy of the measurement so long as the excitation voltage reaches maximum before the Tₒₙ (sampling interval) begins.

The excitation transformer 24 provides the isolation and protection for the driver circuits 22 from the hazardous conditions occurring at the strain gauge load cell 30. In a preferred embodiment, the excitation transformer 24 has the same high voltage ratings as the sense transformer 32 since it is exposed to the same electrical hazards. The excitation transformer 24 protects against high DC voltages, both common and normal mode. Because the excitation frequency is relatively low, i.e., audio band, the transformer self inductance may be high to prevent droop from reducing the signal level. For these high values of self inductance the transformer bandwidth may not be much above the audio range due to the large number of turns required on the transformer core. This limited bandwidth acts to limit the higher frequency noise from passing through the excitation transformer 24 to the driver circuits 22.

The floating excitation voltage signal V_{exc} 28 is applied directly to the strain gauge load cell 30. The strain gauge (Sg) output signal 34 of the strain gauge load cell 30 is transmitted to the input 36 of the sense transformer 32. Note that in this embodiment, there is no semiconductor device on the sensor side of the excitation or sense transformers. This omission (of a semiconductor device on the sensor side of the excitation or sense transformers) is to prevent any failures due to high voltage transients, and high/low temperature.

A shunt calibration resistor 38 is connected to the strain gauge bridge output 40. The shunt calibration resistor 38 is switched in and out of the circuit by the control unit 26 via a relay 42, wherein the control unit 26 is operably connected to the relay 42. The relay 42, used to switch the shunt calibration resistor 38, may possess the same isolation ratings as the excitation and sense transformers 24, 32. The shunt calibration resistor 38 permits calibration of gain through shunt calibration commands 44. The calibration can be performed just prior to making measurements so that parasitics such as series resistance and component temperature drift may be removed from the measurement.

The sense transformer 32 provides protection for the subsequent electronics from the EMI and electrical hazards that occur on the sensor side of the sense transformer 32. Specifically, electrical hazards may occur on the sensor (load cell) side of the sense transformer. In general, both excitation and sensor transformers protect against transients from adversely affecting electronics (e.g., driver circuit electronics, synchronous demodulator, etc). The sense transformer 32 may be sized to pass the modulated Sg signal 34 with minimal droop. The sense transformer 32 passes the differential signal and stops the common mode signals. Also because of the limited bandwidth of a transformer core, some RF reduction may take place above the maximum frequency of core material. The excitation transformer 24 self inductance may be sized to prevent droop from reducing the signal level. The primary to secondary parasitic capacitance may allow some high frequency signals to pass, however, this can be reduced through the use of shields on the primary and or secondary windings.

The output of the sense transformer 32 is the Vᵢₙ voltage signal 46 and is applied to the input of the synchronous demodulator 48.

The Vᵢₙ 48 is synchronously demodulated or rectified as V_{rec} 50. V_{rec} 50 is then applied directly to a RC single pole low pass filter (“RC filter”) 52. The RC filter 52 removes the high frequency modulation components from V_{rec} 50 leaving a continuous output voltage signal Vₒᵤₜ 54 representative of the strain gauge load. The output voltage Vₒᵤₜ 54 is the conditioned strain gauge voltage. The RC filter 52 provides several functions including: setting the bandwidth of the load cell sensor 30, antialias filtering, and removing out of band RF artifacts from the source signal V_{rec}. Because this invention is designed for use in real time applications, in a preferred embodiment, the delay through the processing system may be kept to a minimum. For many applications a single pole roll off characteristic is all the phase shift that can be tolerated. Thus, it is preferred that this system provides a system phase delay that matches the delay seen in an ideal single pole low pass filter with the same break frequency as the RC filter 52.

Vₒᵤₜ 54 of the RC filter 52 is now a continuous representation of the Sg output signal 34. The signal Vₒᵤₜ is in the millivolt range. The signal can now be sent to a gain stage and or an optional filter or an analog to digital converter.

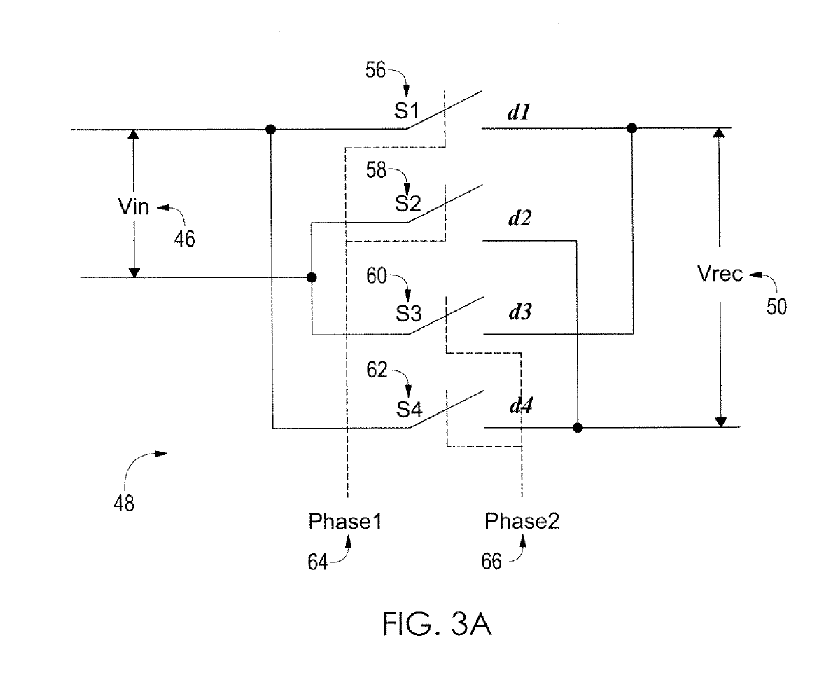

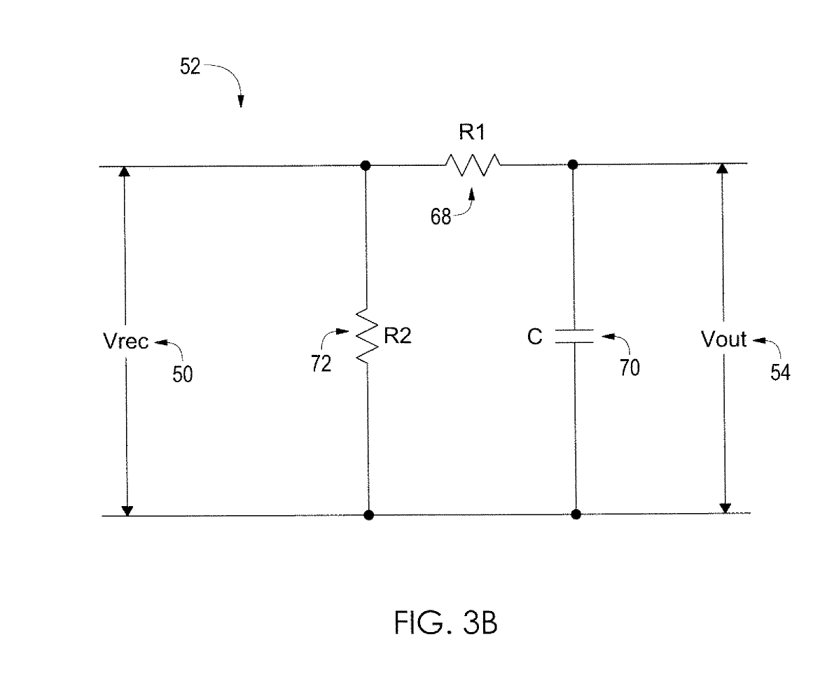

With continued reference to FIG. 1, FIG. 3A is a more detailed schematic of the synchronous demodulator 48. In an embodiment, the synchronous demodulator is comprised of four synchronous switches S1, S2, S3, and S4, 56, 58, 60, and 62, respectively. Said four synchronous switches provide the demodulation function by alternately inverting the input signal in sync with the modulation. Demodulation is controlled by two digital signals. Phase 1 and Phase 2, 64 and 66. With these two signals 64, 66, the gain can be set to +1, −1, short circuit, or open circuit. With continued reference to FIG. 1, FIG. 3B, is a more detailed schematic of an embodiment of the RC filter 52. The R1 resistor 68 and C capacitor 70 forms the basis of a low pass RC filter 52. The R2 resistor 72, is present to control the filter demodulation characteristics. The R2 resistor 72 in conjunction with the Phase A, Phase B signals 64, 66 adjusts the filter performance as defined in the equations below.

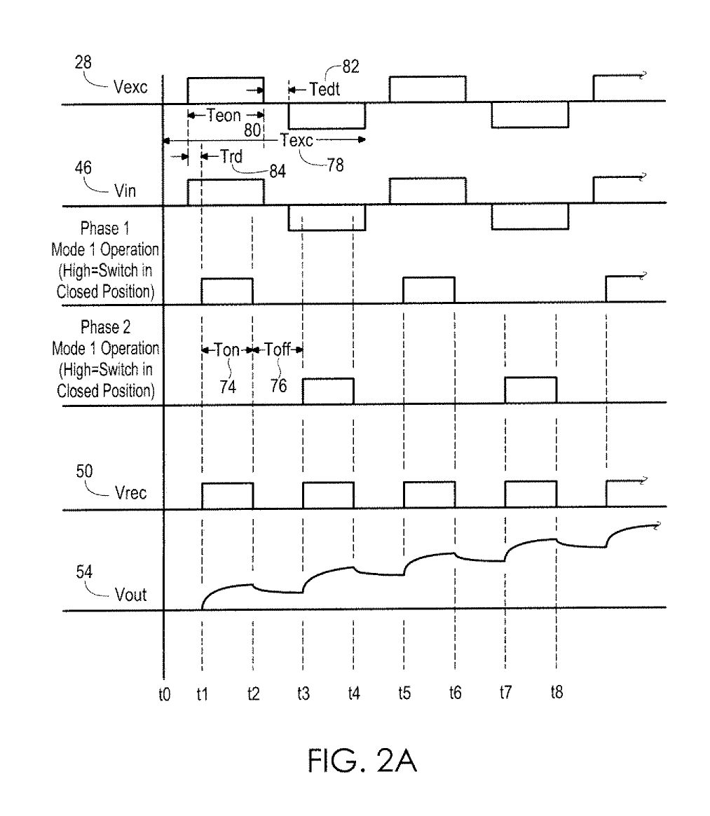

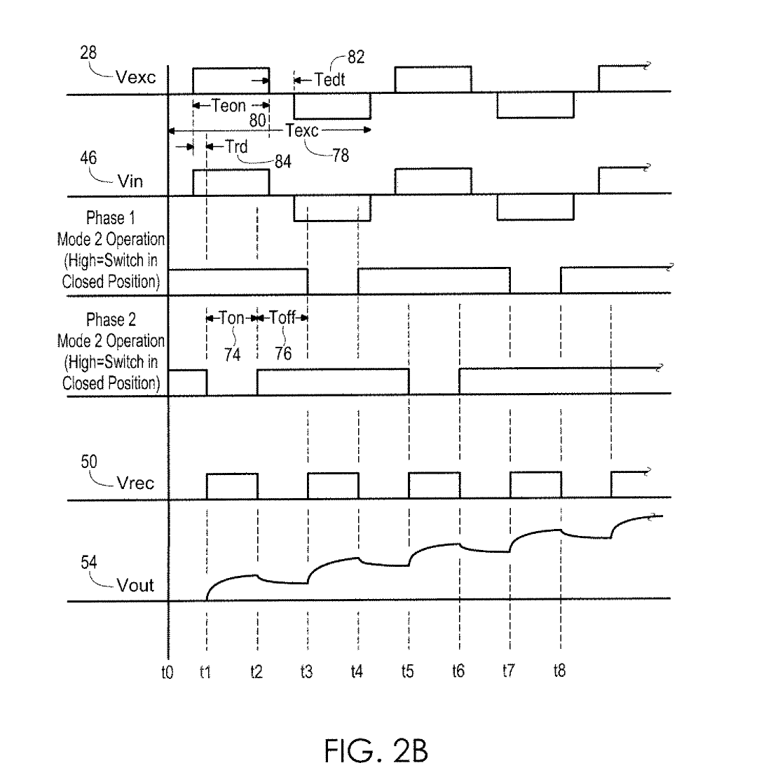

With reference to the timing diagram depicted in FIG. 2A, in Mode 1 operation, for every one half cycle of excitation voltage signal V_{exc} 28, there is one period of “on time” (aka Tₒₙ 74) where the Phase 1 synchronous rectifier switches S1 and S2 (56, 58) are closed, thereby providing a signal to the RC filter 52, and one period of “off time” (aka T_{off} 76) during which all the synchronous rectifier switches S1-S4 (56, 58, 60 62) are open. During the next half cycle the Phase 2 switches S3 and S4 (60, 62) turn on followed by one period of off time. The complete sequence is summarized in Table 1.

TABLE 1
Mode 1 Synchronous Demodulator Operation

| | | Phase 1 | Phase 2 | |
|---|---|---|---|---|
| t | Excitation | (S1, S2) | (S3, S4) | Condition |
| t0-t1 | Dead Time | Open | Open | C discharges through |
| | | | | the R1, R2 network; |
| | | | | τ = (R1 + R2)*C |
| t1-t2 | Positive | Closed | Open | Gain = 1; C charges |
| | Excitation | | | through R1; R2 > R1; |
| | | | | τ = R1*C |
| t2-t3 | Dead Time | Open | Open | C discharges through |
| | | | | the R1, R2 network; |
| | | | | τ = (R1 + R2)*C |
| t3-t4 | Negative | Open | Closed | Closed Gain = −1; C charges |
| | Excitation | | | through R1; R2 > R1; |
| | | | | τ = R1*C |

With reference to the timing diagram depicted in FIG. 2B, in Mode 2 operation, rather than leaving the switches in the open position during the dead time, the switches (56, 58, 60, 62) are in the closed position. This may cause the accumulated charge in capacitor 70 to discharge through R1 resistor 68 and the closed switches during the dead time. So that for every one half cycle of excitation there is one period of on time where half the switches are closed and providing signal to the RC filter 52, and one period of dead (off) time during which all the switches (56, 58, 60, 62) are closed allowing the RC filter 52 to discharge at the same rate as the charge cycle. The complete sequence is summarized in Table 2.

TABLE 2
MODE2 Synchronous Demodulator Operation

| | | Phase 1 | Phase 2 | |
|---|---|---|---|---|
| t | Excitation | (S1, S2) | (S3, S4) | Condition |
| t0-t1 | Dead Time | Closed | Closed | C discharges through |
| | | | | the R1; τ = R1*C |
| t1-t2 | Positive | Closed | Open | Gain = 1; C charges |
| | Excitation | | | through R1; R2 > R1; |
| | | | | τ = R1*C |
| t2-t3 | Dead Time | Closed | Closed | C discharges through |
| | | | | the R1; τ = R1*C |
| t3-t4 | Negative | Open | Closed | Closed Gain = −1; C charges |
| | Excitation | | | through R1; R2 > R1; τ = R1*C |

With continued reference to FIG. 2A, between the excitation pulses of T_{exc}, Tₑₒₙ 78, 80 there is a period T_{edt} 82 where no excitation is applied to the sensor. This period is the dead time and prevents shoot through, the simultaneous conduction of the excitation driver transistors. Looking at the other portions of the excitation voltage signal V_{exc} 28, there is T_{rd} 84, the time between when the excitation pulse rises to the rising edge of the sampling window for the synchronous demodulator. This time delay 84 allows the excitation voltage across the strain gauge bridge to rise to its full amplitude, and allows all the circuit parasitic elements, such as cable capacitance and inductance, to charge and settle out. This eliminates circuit parasitics from affecting the measurement. Changes in the parasitic components caused by temperature, changing lead lengths, changing transformers, and aging components can be eliminated by setting a sufficiently long T_{rd} 84. Since the rise time of the excitation waveform may have been slowed to suppress EMI, the T_{rd} 84 can also be adjusted to handle large excitation rise times. This technique may assure that when the synchronous demodulator closes its switches, the input signal has settled.

The Vᵢₙ 46 and V_{rec} 50 are also depicted in FIG. 2A. Comparing the Mode 1 Phase 1, Phase 2 commands from the control unit with the Vᵢₙ 46 waveform shows the windowing that occurs during the rectification cycle. Since the T_{rd} 84 eliminates the effects of parasitic effects, spurious signals are prevented from entering the RC Filter 52. Comparing V_{rec} 50 and Vᵢₙ 46 shows the effects of windowing and rectification on the Vᵢₙ 46 voltage signal. The signal V_{rec} 50 is now a windowed representation of the mechanical force applied to the strain gauge. This can be expressed mathematically by equation 1.3 wherein its derivation is expressed below:

K_{sc}*M*F_{sg}=Sg (1.0)

Assume a sense transformer 32 ratio of 1:1, then,

Vᵢₙ=Sg,

and,

Ksc*M*F_{sg}=Vᵢₙ (1.1)

V_{rec}=Vᵢₙ*M (1.2).

Substituting for Vᵢₙ in equation 1.2 yields:

V_{rec}=K_{sc}*M*F_{sg}*M

V_{rec}=K_{sc}*F_{sg}*M²

V_{rec}=K_{sc}*F_{sg} (1.3)

where,

Ksc=Strain Gauge Factor, Relates the input force to the strain gauge output voltage;

Fsg=Mechanical force applied to strain gauge; and

M=Modulation Coefficient, +1, −1, 0, derived from the chipping code and applied to the strain gauge as the excitation and used by the synchronous demodulator to recover the original signal.

Equation 1.3 illustrates that Vᵢₙ and V_{rec} have the same amplitude, however V_{rec} has been windowed by the Phase 1 and Phase 2 control lines. The effects of this windowing will be fully described infra. Therefore equation 1.3 demonstrates that the system function of measuring force on the load cell to output voltage can be generally described as:

$$H = \frac{{V}_{out}}{{V}_{rec}} \qquad ( 1.4 )$$

This form of the transfer function will be utilized to describe the system function for the remainder of this specification.

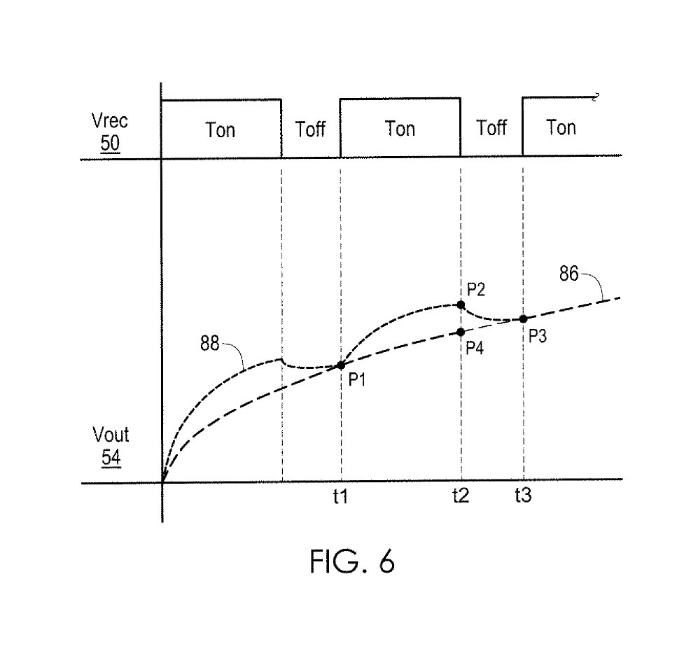

With reference to FIG. 6 there are two traces shown on the Vₒᵤₜ 54 axis. The curve 86, in accordance with the following formula: u(t)·(1-e^{-t/τ1}), represents the step response of an ideal single pole low pass filter. This curve 86 represents the ideal response which is a goal of the invention and its embodiments described herein to duplicate. The second curve represents an exemplary response to mimic the ideal performance. With continued reference to FIG. 6 the demodulator transfer function for the case where the excitation duty cycle is held constant is derived as follows. The Vₒᵤₜ trace 88 illustrates that there are two distinct regions of operation corresponding to the filter charge discharge cycle. The region from t1-t2 is the Tₒₙ period during which the output voltage Vₒᵤₜ rises exponentially. The region from t2-t3 is the T_{off} period during which the voltage Vₒᵤₜ declines exponentially. For Mode 1 operation the time constant for the T_{off} period is different from the time constant for the charge period. For Mode 2 operation the two time constants are the same. In either case the equations for calculating the output voltage are the same, only the correct values for the time constants may be inserted to model the demodulator function and RC filter.

The equations to describe to output voltage and transfer function of this invention are shown below. For the Tₒₙ period the output voltage Vₒᵤₜ is determined by the charging cycle. It is known that for a complete response for a linear time invariant circuit the output response is:

Vₒᵤₜ_{_{Ton}}=Zero_State_Response+Zero_Input_Response (2.0)

Now:

$$Zero\_State \_Response = {V}_{rec} \cdot ( 1 - exp ( - \frac{{T}_{on}}{τ 1} ) ) ; and$$

$$Zero\_Input \_Response = {V}_{initial} P 1 \cdot exp ( - \frac{{T}_{on}}{τ 1} )$$

Substituting into equation 2.0:

$${V}_{{out}_{Ton}} = {V}_{rec} \cdot ( 1 - exp ( - \frac{{T}_{on}}{τ 1} ) ) + {V}_{initial} P 1 \cdot exp ( - \frac{{T}_{on}}{τ 1} )$$

Now rearranging terms:

$${V}_{{out}_{Ton}} = {V}_{rec} - {V}_{rec} \cdot exp ( - \frac{{T}_{on}}{τ 1} ) + {V}_{initial} P 1 \cdot exp ( - \frac{{T}_{on}}{τ 1} )$$

Now adding +/−VᵢₙᵢₜᵢₐₗP1 terms to the right side of the equation and rearranging:

$${V}_{{out}_{Ton}} = {V}_{rec} - {V}_{rec} \cdot exp ( - \frac{{T}_{on}}{τ 1} ) + {V}_{initial} P 1 \cdot exp ( - \frac{{T}_{on}}{τ 1} ) + {V}_{initial} P 1 - {V}_{initial} P 1 ;$$

$${V}_{{out}_{Ton}} = {V}_{initial} P 1 + {V}_{rec} - {V}_{rec} \cdot exp ( - \frac{{T}_{on}}{τ 1} ) - {V}_{initial} P 1 + {V}_{initial} P 1 \cdot exp ( - \frac{{T}_{on}}{τ 1} ) ;$$

$${V}_{{out}_{Ton}} = {V}_{initial} P 1 + ( 1 - exp ( - \frac{{T}_{on}}{τ 1} ) ) \cdot {V}_{rec} + ( - 1 + exp ( - \frac{{T}_{on}}{τ 1} ) ) \cdot {V}_{initial} P 1 ;$$

$${V}_{{out}_{Ton}} = {V}_{initial} P 1 + {V}_{rec} \cdot ( 1 - exp ( - \frac{{T}_{on}}{τ 1} ) ) - {V}_{initial} P 1 \cdot ( 1 - exp ( - \frac{{T}_{on}}{τ 1} ) ) .$$

Now the complete response for the Tₒₙ period is:

$${V}_{{out}_{Ton}} = {V}_{initial} P 1 + ( {V}_{rec} - {V}_{initial} P 1 ) \cdot ( 1 - exp ( - \frac{{T}_{on}}{τ 1} ) ) \qquad ( 2.2 )$$

Where:
Vₒᵤₜ_{_{Ton}} Output voltage at the end of the period Tₒₙ, designated by point P2 on FIG. 6;
V_{rec} Input voltage from the stain gauge multiplied by the transformer turns ratio and demodulated by the synchronous rectifier switches. Transformer turns ratio assumed to be 1:1 in this analysis;
VᵢₙᵢₜᵢₐₗP1 Initial voltage across the capacitor C at the instant the Tₒₙ period begins, designated by point P1 on FIG. 6;
Tₒₙ On time of the synchronous demodulator switches; and
τ1 time constant during the Tₒₙ period.

Now for the T_{off} period the output voltage is also given by equation 2.0, however since there is no input voltage during this period there will be no contribution from the zero-state response term. This leaves only the zero-input response:

$${V}_{{out}_{Toff}} = {V}_{initial} P 2 \cdot exp ( - \frac{{T}_{off}}{τ 2} ) \qquad ( 2.3 )$$

where:
Vₒᵤₜ_{_{Toff}} Output voltage at the end of the period T_{off} designated by point P3 in FIG. 6;
T_{off} Off time of synchronous demodulator switches;
τ2 Time constant during the T_{off} period; and
VᵢₙᵢₜᵢₐₗP2 Initial voltage across the capacitor C at the instant the T_{off} period begins. This can also be thought of as the final voltage across the capacitor after the on period. Designated by point P2 in FIG. 6

Now since the output voltage of the charge cycle, Tₒₙ, from t1 to t2 is the initial condition value across the capacitor C for the discharge cycle, T_{off}, from t2 to t3, then the output voltage at the end of a complete charge-discharge cycle can be expressed by combining equations 2.2 and 2.3 by replacing the VᵢₙᵢₜᵢₐₗP2 term in equation 2.3 with the right side of equation 2.2.

$${V}_{{out}_{Toff}} = V initial P 2 \cdot exp ( - \frac{Toff}{τ 2} ) \qquad ( 2.3 )$$

Rewriting equation 2.4 in the direct form of a difference equation, yields an equation expressing a discrete output voltage at intervals of T for the cases where Tₒₙ and T_{off} are constant, i.e., a fixed frequency operation. Note the substitution of Vₒᵤₜ_{ₙ₋₁} for VᵢₙᵢₜᵢₐₗP1:

$${V}_{{out}_{n}} = [ {Vout}_{n - 1} + ( Vrec - {Vout}_{n - 1} ) \cdot ( 1 - exp ( - \frac{Ton}{τ 1} ) ) ] \cdot exp ( - \frac{Toff}{τ 2} ) \qquad ( 2.5 )$$

And:

T=Tₒₙ+T_{off};

t=nT,

Where:
Vₒᵤₜ_{ₙ} Output voltage occurring at the end of a charge-discharge cycle;
Vₒᵤₜ_{ₙ₋₁} Output voltage at beginning of charge-discharge cycle. This is substituted for VᵢₙᵢₜᵢₐₗP1 in equation 2.5;
V_{rec} Input voltage from the stain gauge multiplied by the transformer turns ratio and demodulated by the synchronous rectifier switches;
Tₒₙ On time of the synchronous demodulator switches, a constant;
T_{off} Off time of the synchronous demodulator switches, a constant;
τ1 Time constant during the Tₒₙ period R1*C;
τ2 Time constant during the T_{off} period;
T One charge—discharge period; and
t Time in seconds

The transfer function of the system can be derived from equation 2.5.

Now let:

$$K 1 = ( 1 - exp ( - \frac{Ton}{τ 1} ) ) ; and$$

$$K 2 = exp ( - \frac{Toff}{τ 2} ) .$$

Substituting yields:

Vₒᵤₜ_{ₙ}=(Vₒᵤₜ_{ₙ₋₁}+(V_{rec}-Vₒᵤₜ_{ₙ₋₁})·K1)˜K2

Expanding Terms:

Vₒᵤₜ_{ₙ}=K2·Vₒᵤₜ_{ₙ₋₁}+K1·K2·(V_{rec}-Vₒᵤₜ_{ₙ₋₁})

Vₒᵤₜ_{ₙ}=K2·Vₒᵤₜ_{ₙ₋₁}+K1·K2·V_{rec}−K1·K2·Vₒᵤₜ_{ₙ₋₁}

Taking the Z transform:

Vₒᵤₜ(z)=K2·z⁻¹·Vₒᵤₜ(z)+K1·K2·V_{rec}(z)−K1·K2·z⁻¹·Vₒᵤₜ(z)

Grouping like terms:

Vₒᵤₜ(z)−K2·z⁻¹·Vₒᵤₜ(z)+K1·K2·z⁻¹·Vₒᵤₜ(z)=K1·K2·V_{rec}(z)

Vₒᵤₜ(z)(1−K2·z⁻¹+K1·K2·z⁻¹)=V_{rec}(z)·K1·K2

Now the transfer function (H(z)) is:

$$\begin{matrix}\frac{Vout ( z )}{Vrec ( z )} = K 1 \cdot K 2 / ( 1 - K 2 \cdot {z}^{- 1} + K 1 \cdot K 2 \cdot {z}^{- 1} ) \\ = K 1 \cdot K 2 / ( 1 + ( K 1 \cdot K 2 - K 2 ) {z}^{- 1} )\end{matrix}$$

$$H ( z ) = \frac{K 1 \cdot K 2}{1 + ( K 1 \cdot K 2 - K 2 ) {z}^{- 1}}$$

Convert this transfer function into s domain.

$$\begin{matrix}z = {exp}^{j \cdot ω \cdot T} = {e}^{j \cdot ω \cdot T} \\ H ( s ) = \frac{K 1 \cdot K 2}{1 + ( K 1 \cdot K 2 - K 2 ) {e}^{- j \cdot ω \cdot T}} & ( 2.6 ) \\ Θ = atan ( IM ( H ( s ) ) / RE ( H ( s ) ) ) & ( 2.7 )\end{matrix}$$

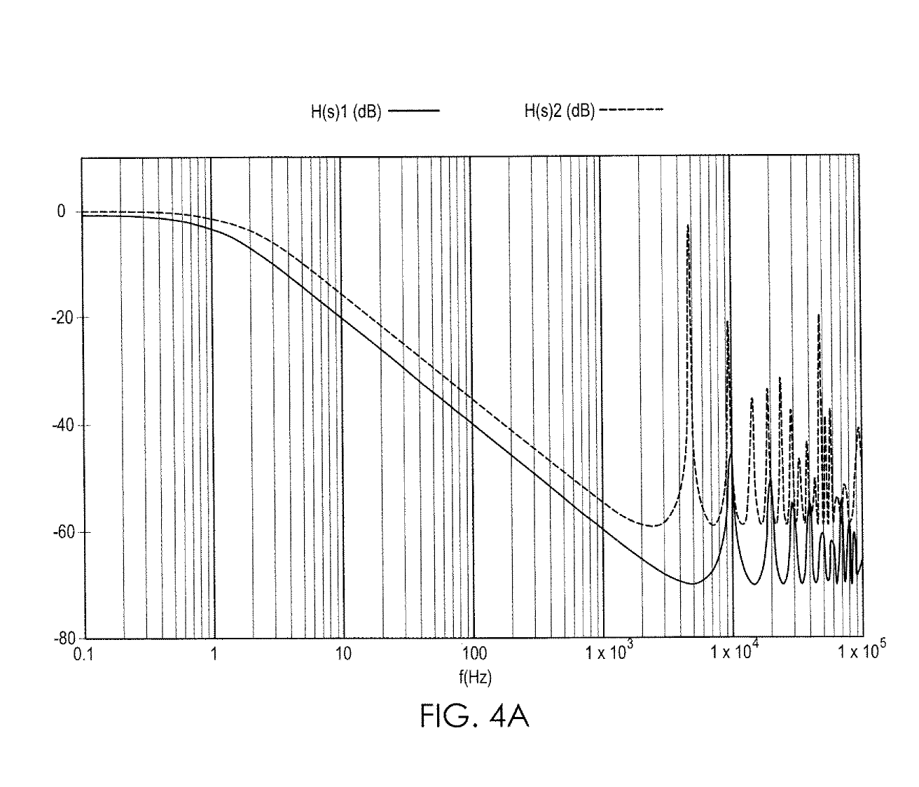

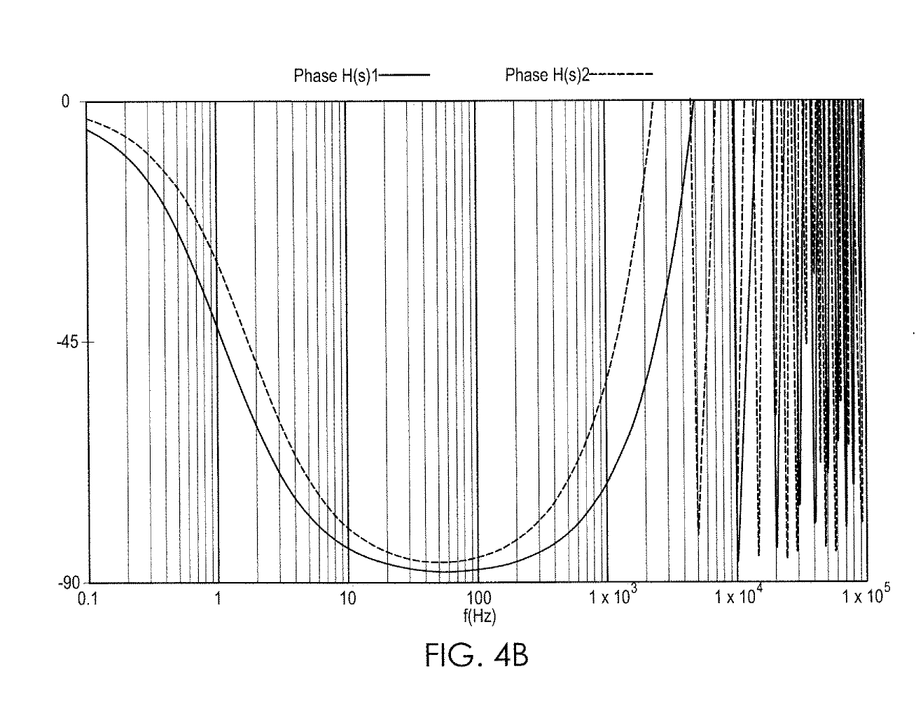

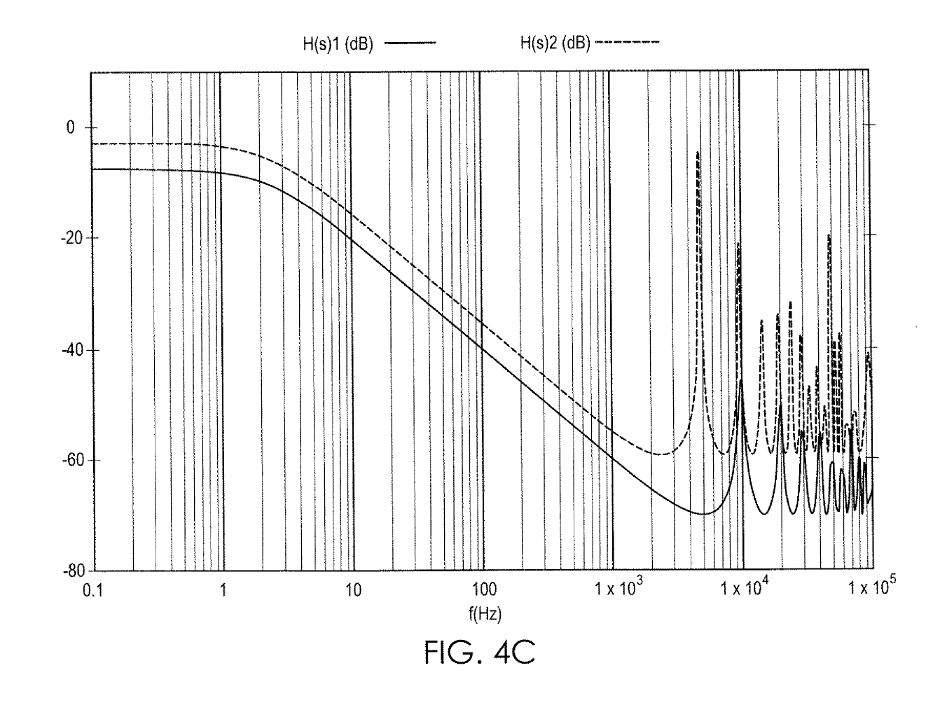

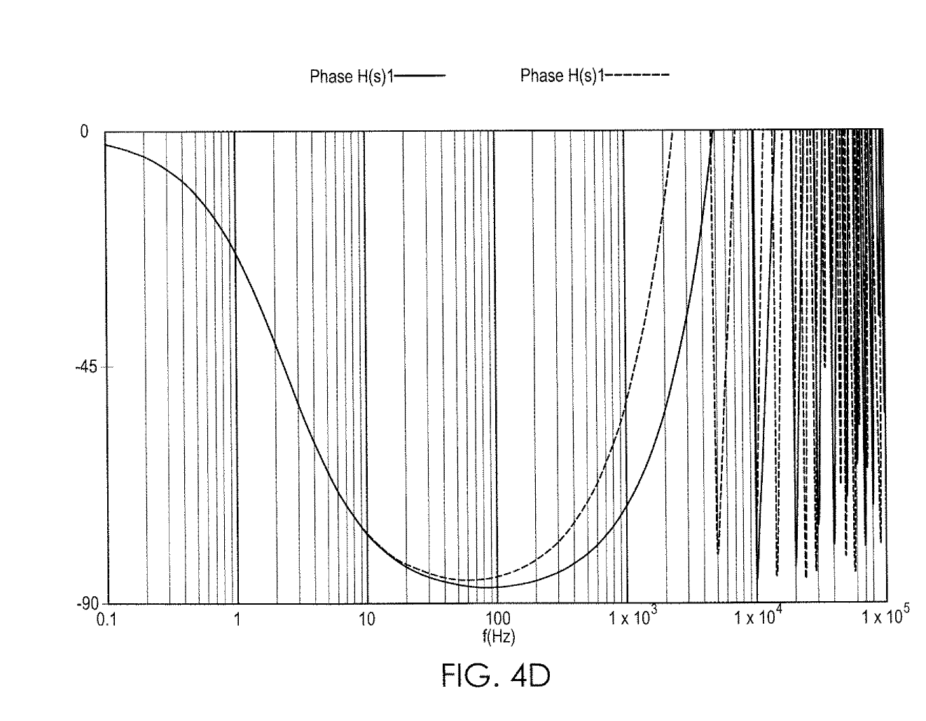

In an embodiment, FIG. 4A and FIG. 4B show the performance for Mode 1 operation in accordance to FIG. 2A for two different duty cycles of the excitation signal.

The following characteristics are demonstrated by these plots:
τ1<<τ2 for Mode 1 operation;
Output amplitude in the pass band remains constant however the filter corner frequency changes with the duty cycle; and
The output exhibits the roll off and phase response of a continuous single pole low pass filter.

In an embodiment, FIG. 4C and FIG. 4D show the performance for Mode 2 operation in accordance to FIG. 213 for two different duty cycles of the excitation signal. These plots illustrate the following characteristics:
τ1=τ2 for Mode 2 operation;
Output amplitude in the pass band changes however the filter corner frequency remains the same; and
The output exhibits the amplitude roll off and phase response of a continuous single pole low pass filter.

Table 3 illustrates the circuit constants used for these plots illustrated in FIGS. 4A, 4B, 4C, and 4D.

TABLE 3
Circuit Constants for Constant Frequency Demodulator
Operations Associated with Performance Plots
Illustrated in FIGS. 4A, 4B, 4C, and 4D

| | FIGS. 4A and 4B | FIG. 4C and 4D |
|---|---|---|
| R1 | 20K Ohms | 20K Ohms |
| C | 3.4 μF | 3.4 μF |
| R2 | 200K Ohms | R2 >> R1 |
| τ1 | 0.068 | 0.068 |
| τ2 | 0.748 | 0.068 |
| Exemplary | Constant Frequency | Constant Frequency |
| Constants for | Operation; | Operation; |
| Phase H(s)1 Curve | Ton = 43 μs; | Ton = 43 μs; |
| | Toff = 59 μs | Toff = 59 μs |
| Exemplary | Constant Frequency | Constant Frequency |
| Constants for | Operation; | Operation; |
| Phase H(s)2 Curve | Ton = 150 μs; | Ton = 150 μs; |
| | Toff = 59 μs | Toff = 59 μs |

With continued reference to FIGS. 4A and 4B, the differences between Mode 1 and Mode 2 operations are seen as a result of changing the duty cycle of the excitation waveform. Mode 1 gives constant amplitude and varying corner frequency. Mode 2 gives constant corner frequency and varying amplitude. A method will now be shown to correct the Mode 2 characteristic of changing corner frequency with changing duty cycle, to allow spread spectrum modulation and still maintain the amplitude and phase response of a continuous single pole low pass filter.

Equations 2.6 and 2.7 above show the transfer function for fixed frequency modulation. In order to minimize the EMI emissions caused by an AC excitation signal it would be advantageous to employ spread spectrum techniques however the use of spread spectrum may cause changes to the filter performance as discussed above. A form of compensation is now shown to eliminate the effects of changing to spread spectrum modulation. First an equation is derived (ref: equation 5.5 below) to express output voltage as a function of duty cycle, then a factor is found that will determine the required amplitude modulation of the spread spectrum chipping code that will compensate for the effects of the spread spectrum modulation (ref: equation 5.10 below).

From electronic circuit theory it is known that the response of a linear time invariate circuit is given by its zero-state response plus its zero-input response. With reference to FIG. 6 and to FIG. 2B, the two curves are broken into segments and are expressed in terms of their zero-state and zero-input responses. Specifically, for the t1-t2 (aka P1-P4) segment of the Reference curve, the expression is as follows:

$$Vp 4 = Vrec ( 1 - exp ( - \frac{Ton}{τ 1} ) ) + Vp 1 \cdot exp ( - \frac{Ton}{τ 1} ) ; \qquad ( 5.0 )$$

for the t1-t2 (aka P1-P4) demodulator curve, the expression is as follow:

$$Vp 2 = K \cdot Vrec ( 1 - exp ( - \frac{Ton}{τ 1} ) ) + Vp 1 \cdot exp ( - \frac{Ton}{τ 1} ) ; \qquad ( 5.1 )$$

for the t2-t3 (aka P2-P3) segment Reference curve, the expression is as follow:

$$Vp {3}_{c} = Vrec ( 1 - exp ( - \frac{Toff}{τ 1} ) ) + Vp 4 \cdot exp ( - \frac{Toff}{τ 1} ) ; \qquad ( 5.2 )$$

and for the demodulator curve, the expression is as follows:

$$Vp {3}_{m} = Vp 2 \cdot exp ( - \frac{Ton}{τ 2} ) . \qquad ( 5.3 )$$

where
V_{rec} is the rectified voltage at the input to the RC filter;
Vp1 is the initial condition voltage at the start of the charge-discharge cycle;
Vp2 is the demodulator output voltage from the filter at the end of the charge (Tₒₙ) period;
Vp3_{c} is the output voltage at the end of a charge discharge cycle (Tₒₙ+T_{off}) caused by a continuous single pole low pass filter;
Vp3ₘ is the voltage occurring at the end of a charge discharge cycle (Tₒₙ+T_{off}) caused by the synchronous demodulator. Both the modulator curve and the reference curve may have the same value at this point;
Vp4 is the output voltage on the reference curve at the end of the charge cycle (Tₒₙ);
Tₒₙ is the on time of the demodulator, a function of the spreading code;
T_{off} is the off time of the demodulator;
τ1 is the R1*C time constant of the demodulator filter during the on time. During this period the demodulator switches are connecting the input signal to the RC filter; and
τ2 is the R1*C time constant of the demodulator filter during the off time. During this period the RC filter is discharging at a rate determined by τ2.

Substituting the right hand side of equation 5.0 for Vp4 in equation 5.2:

$$Vp {3}_{c} = Vrec ( 1 - exp ( - \frac{Toff}{τ 1} ) ) + [ Vrec ( ( 1 - exp ( - \frac{Ton}{τ 1} ) ) + Vp 1 \cdot exp ( - \frac{Ton}{τ 1} ) ) ] \cdot exp ( - \frac{Toff}{τ 1} ) \qquad ( 5.4 )$$

Substituting the right hand side of equation 5.1 for Vp2 in equation 5.3:

$$Vp {3}_{m} = [ K \cdot Vrec ( 1 - exp ( - \frac{Ton}{τ 1} ) ) + Vp 1 \cdot exp ( - \frac{Ton}{τ 1} ) ] \cdot exp ( - \frac{Toff}{τ 1} ) \qquad ( 5.5 )$$

Note the addition of K in equation 5.5. K is applied only to the input voltage and not the entire expression. In the actual circuit the excitation voltage is varied which causes the amplitude of the input signal to vary.

Vp3ₘ is the output voltage. Vp3_{c} is the equation of the output voltage for the desired response of a continuous single pole low pass filter. Vp3ₘ and Vp3_{c} are the time domain response curves to a unit step function u(t) so Vp3ₘ and Vp3_{c} are time domain representations of the complete transfer function setting the equations equal to each other forces Vp3ₘ to have the same transfer function as the ideal response Vp3_{c}. Then solve for K, which represents the modulation to correct errors caused by spread spectrum modulation. Therefore, set the Vp3 equations above equal to each other (equations 5.4 and 5.5):

$$\begin{matrix} Vp {3}_{m} = Vp {3}_{c} & ( 5.6 ) \\ ( K \cdot Vrec \cdot K 1 + Vp 1 \cdot K 6 ) K 4 = Vrec \cdot K 2 + ( Vrec \cdot K + Vp 1 \cdot K 6 ) K 3 \\ Where , \\ K 1 = 1 - exp ( - \frac{Ton}{τ 1} ) K 2 = 1 - exp ( - \frac{Toff}{τ 1} ) \\ K 3 = exp ( - \frac{Toff}{τ 1} ) K 4 = exp ( - \frac{Toff}{τ 2} ) K 6 = exp ( - \frac{Ton}{τ 1} ) & ( 5.7 )\end{matrix}$$

K is a coefficient which corrects for the changing demodulator duty cycle operation by amplitude modulating the strain gauge excitation voltage. For every combination of Tₒₙ and T_{off} there is a value of K which will maintain a single pole response characteristic for the synchronous demodulator.

Now solve equation 5.7 for K:

(K·V_{rec}·K1+Vp1·K6)K4=V_{rec}·K2+(V_{rec}·K1+Vp1·K6)K3;

K·V_{rec}·K1·K4+K4·Vp1·K6=V_{rec}·K2+V_{rec}·K1·K3+Vp1·K6·K3;

K·K4·V_{rec}·K1=V_{rec}·K2+V_{rec}·K1·K3+Vp1·K6·K3−K4·Vp1·K6;

$$K = \frac{Vrec \cdot K 2 + Vrec \cdot K 1 \cdot K 3 + Vp 1 \cdot K 6 \cdot K 3 - K 4 \cdot Vp 1 \cdot K 6}{K 1 \cdot K 4 \cdot Vrec} ;$$

$$K = \frac{Vrec ( K 2 + K 1 \cdot K 3 ) + Vp 1 \cdot K 6 \cdot K 3 - K 4 \cdot Vp 1 \cdot K 6}{Vrec \cdot K 1 \cdot K 4} ;$$

$$K = \frac{K 2 + K 1 \cdot K 3}{K 1 \cdot K 4} + \frac{Vp 1 \cdot K 6 \cdot K 3}{Vrec \cdot K 1 \cdot K 4} - \frac{K 4 \cdot Vp 1 \cdot K 6}{Vrec \cdot K 1 \cdot K 4} .$$

Now substitute the original expressions into the two right hand terms:

$$K = \frac{K 2 + K 1 \cdot K 3}{K 1 \cdot K 4} + \frac{Vp 1 ( exp ( - \frac{Ton}{τ 1} ) \cdot exp ( - \frac{Toff}{τ 1} ) )}{Vrec \cdot K 1 \cdot K 4} - \frac{Vp 1 ( exp ( - \frac{Ton}{τ 1} ) \cdot exp ( - \frac{Toff}{τ 2} ) )}{Vrec \cdot K 1 \cdot K 4} . \qquad ( 5.8 )$$

The two right hand terms of equation 5.8 are identical except for the τ1 and τ2 time constants. For Mode 2 operation, τ1=τ2, the two right hand terms are equal and cancel each other out of the equation so that:

$$\begin{matrix} K = \frac{K 2 + K 1 \cdot K 3}{K 1 \cdot K 4} \\ Or & ( 5.9 ) \\ K = \frac{( 1 - exp ( - \frac{Toff}{τ 1} ) ) + ( ( 1 - exp ( - \frac{Ton}{τ 1} ) ) \cdot exp ( - \frac{Toff}{τ 1} ) )}{( 1 - exp ( - \frac{Ton}{τ 1} ) ) \cdot exp ( - \frac{Toff}{τ2} )} ; & \\ K = \frac{( 1 - exp ( - \frac{Toff}{τ 1} ) ) + ( ( \begin{matrix}exp ( - \frac{Toff}{τ 1} ) - \\ exp ( - \frac{Ton + Toff}{τ 1} )\end{matrix} ) )}{( 1 - exp ( - \frac{Ton}{τ 1} ) ) \cdot exp ( - \frac{Toff}{τ2} )} ; & \\ K = \frac{( 1 - exp ( - \frac{Ton + Toff}{τ 1} ) )}{( 1 - exp ( - \frac{Ton}{τ 1} ) ) \cdot exp ( - \frac{Toff}{τ 2} )} ; & ( 5.10 ) \\ where τ 1 = τ 2. & \end{matrix}$$

Equation 5.10 demonstrates that the amplitude modulation coefficient K is dependent only on the time constants τ1 and τ2. This equation also indicates that since τ1=τ2, this equation is only valid for the case of Mode 2 demodulator operation.

It is the relative magnitudes of the K coefficients that allow the demodulator to operate with a single pole roll off characteristic. In order to correct the amplitude errors caused by the variable duty cycle during Mode 2 operation, the excitation amplitude may vary in direct proportion to the K coefficient. For example if a coefficient of 1.0 corresponds to an excitation voltage of 10V then the coefficient for Tₒₙ 1.5 corresponds to an excitation voltage of 15V. The actual amplitudes for the excitation voltages are dependent on circuit parameters and the strain gauge bridge power rating, but the relative amplitudes may match the K coefficients.

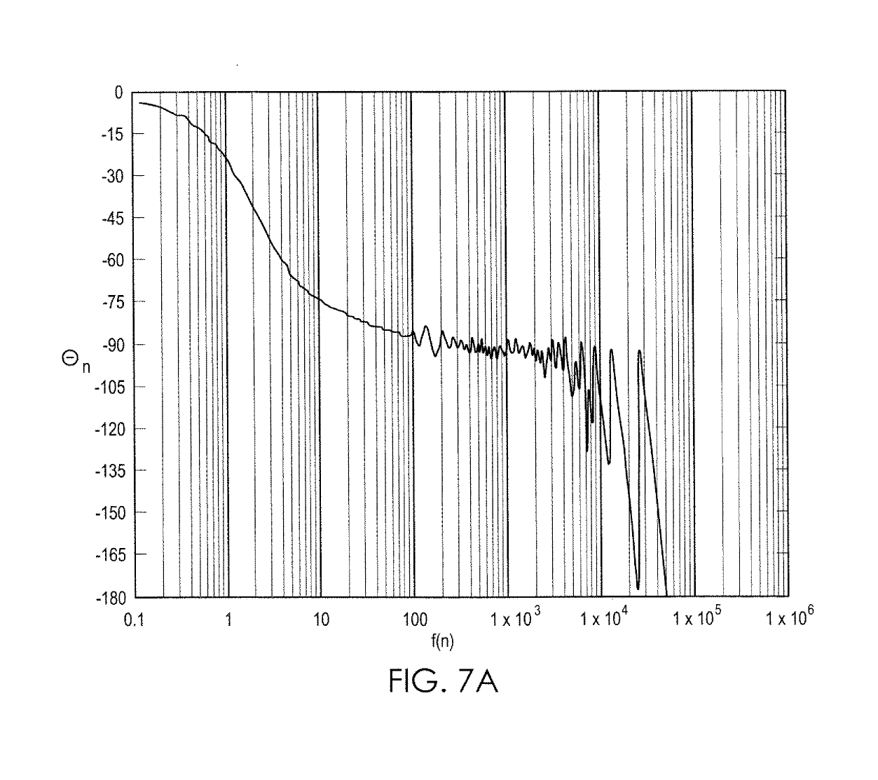

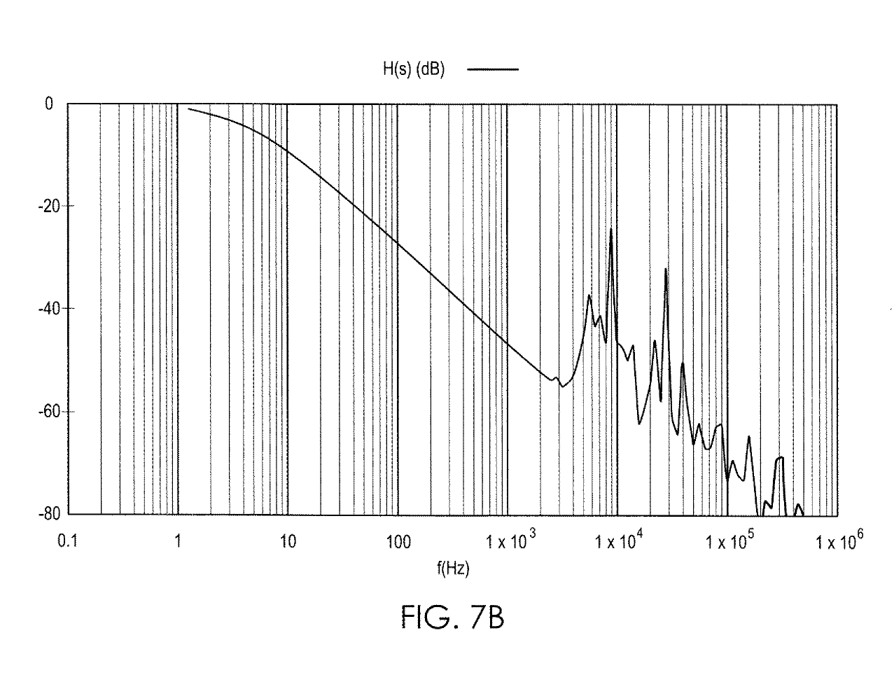

Table 4, below, shows a 16 chip pseudo random code (albeit any size chipping code can be used), wherein FIGS. 7A and 8B depict an example of circuit performance using this code. K is determined by equation 5.10. With reference to FIGS. 7A and 7B, note the flat passband response, the constant break frequency and single pole roll off phase characteristic.

TABLE 4
16 Chip Pseudo Random Code

| Seq# | Ton | | Toff | K |
|---|---|---|---|---|
| 1 | 44 | μsec | 59 μsec | 2.342 |
| 2 | 50 | μsec | 59 μsec | 2.181 |
| 3 | 60 | μsec | 59 μsec | 1.984 |
| 4 | 70 | μsec | 59 μsec | 1.844 |
| 5 | 80 | μsec | 59 μsec | 1.738 |
| 6 | 90 | μsec | 59 μsec | 1.656 |
| 7 | 95 | μsec | 59 μsec | 1.622 |
| 8 | 100 | μsec | 59 μsec | 1.591 |
| 9 | 90 | μsec | 59 μsec | 1.656 |
| 10 | 80 | μsec | 59 μsec | 1.738 |
| 11 | 90 | μsec | 59 μsec | 1.656 |
| 12 | 100 | μsec | 59 μsec | 1.591 |
| 13 | 110 | μsec | 59 μsec | 1.537 |
| 14 | 120 | μsec | 59 μsec | 1.492 |
| 15 | 140 | μsec | 59 μsec | 1.422 |
| 16 | 150 | μsec | 59 μsec | 1.394 |

Table 5, below, depicts the circuit constants used for the plots in FIGS. 7A and 7B in accordance with Mode 2 Demodulator operations as illustrated in FIG. 2B and the 16 Chip Pseudo Random Code defined in Table 4.

TABLE 5
Initial Conditions for Spread Spectrum Example

| Initial Condition | Value | |
|---|---|---|
| Corner Frequency | 2.3 | Hz |
| R1 | 20K | Ohms |
| R2 | 200K | Ohms |
| C | 3.4 | μF |

| | |
|---|---|
| τ1 | 0.68 |
| τ2 | 0.68 |

By adjusting the 16 chip pseudo random code (aka “chipping code”), the radiated EMI can be controlled to acceptable levels. The chipping code can also be adjusted to improve out of band noise rejection at certain frequencies of interest.

Any patents or publications mentioned in this specification are indicative of the levels of those skilled in the art to which the invention pertains. These patents and publications are herein incorporated by reference to the same extent as if indicated that each individual publication was to be incorporated specifically and individually by reference.

One skilled in the art will readily appreciate that the present invention is well adapted to carry out the objects and obtain the ends and advantages mentioned, as well as those inherent therein. It will be apparent to those skilled in the art that various modifications and variations can be made in practicing the present invention without departing from the spirit or scope of the invention. Changes therein and other uses will occur to those skilled in the art which are encompassed within the spirit of the invention as defined by the scope of the claims.

What is claimed is:

1. Circuitry for conditioning an analog strain gauge output signal, comprising:
means for modulating an excitation waveform input signal;
an analog strain gauge load cell electrically connected to receive an input signal and configured to produce a modulated output signal;
a synchronous demodulator electrically connected to receive said modulated output signal and configured to produce a demodulated output signal;
a passive RC filter electrically connected to receive said demodulated output signal and configured to produce a conditioned strain gauge output signal;
means for electrically isolating an input signal to or an output signal from an analog strain gauge load cell; and
a control unit operably integrated within said circuitry.

2. The circuitry of claim 1, further comprising a calibration shunt electrically connected between said analog strain gauge load cell and said control unit.

3. The circuitry of claim 2, wherein said calibration shunt comprises:
a resistor electrically connected to the output of said analog strain gauge load cell;
a relay configured to switch said resistor into and out of the circuitry,
wherein said relay is operably connected to said control unit.

4. The circuitry of claim 1, wherein said means for modulating an excitation waveform comprises:
a DC power supply; and
transformer driver circuits electrically connected to said DC power supply,
wherein said control unit is operably connected to said transformer driver circuits and said DC power supply.

5. The circuitry of claim 1, wherein said means for modulating an excitation waveform includes means for spread spectrum modulation.

6. The circuitry of claim 1, wherein said output strain gauge signal is a function of an excitation waveform signal and a mechanical load applied to said strain gauge load cell.

7. The circuitry of claim 1, wherein said synchronous rectifier comprises four analog switches configured to rectify said modulated output signal in synchrony with modulating said excitation waveform input signal.

8. The circuitry of claim I wherein said passive RC filter comprises a resistor and capacitor configured as a single pole low pass filter.

9. The circuitry of claim 1, wherein said means for isolating an input signal to or an output signal from said strain gauge load cell comprises:
an excitation transformer electrically connected between said means for modulating an excitation waveform signal and said strain gauge load cell; and
a sense transformer electrically connected between said strain gauge load cell and said synchronous demodulator.

10. The circuitry of claim 1, wherein said means for isolating an input signal to or an output signal from said strain gauge load cell includes isolating other input to output galvanic currents.

11. A method for conditioning an analog strain gauge output signal in real time, comprising:
sensing a load applied to an analog strain gauge load cell;
modulating an excitation waveform input signal;
isolating said modulated excitation waveform input signal;
applying said isolated modulated excitation waveform signal to said strain gauge load cell;
obtaining a modulated output signal that is a function of said isolated modulated excitation waveform and said applied load;
isolating said modulated output signal;
and
demodulating said isolated modulated output signal in synchrony with modulating said excitation waveform input signal thereby conditioning said analog strain gauge output signal in real time.

12. The method of claim 11, further comprising:
calibrating said strain gauge load cell.

13. The method of claim 12, wherein said calibrating step comprises:
shunting an output signal generated by said strain gauge load cell through a calibration resistor via a relay operably opened via a control unit; calibrating said signal; and closing said relay.

14. The method of claim 11, wherein said demodulating step comprises:
synchronously rectifying said isolated modulated output signal to produce a rectified signal;
filtering said rectified signal via an RC filter to produce said conditioned analog strain gauge signal.

15. The method of claim 14, wherein said synchronously rectifying step comprises alternately inverting said isolated modulated output signal in synchrony with said modulating step.

16. The method of claim 11, wherein said strain gauge load cell is physically mounted in a space environment such that said modulating and demodulating steps are performed in a remote location from and protected from the space environment.

17. The method of claim 16, wherein said isolating steps are performed at an interface between the space environment and the remote location.

18. The method of claim 11, wherein said applied load is generated between two vehicles during a docking maneuver in the space environment.

19. An analog strain gauge conditioning system, comprising:
a DC power supply;
transformer driver circuits operably connected to said power supply;
an analog strain gauge load cell operably connected to said driver circuits;
an excitation transformer operably disposed between said driver circuits and said analog strain gauge load cell;
a synchronous demodulator, including a gain amplifier, operably connected to said analog strain gauge load cell;
a sense transformer;
a control unit;
a calibration shunt operably disposed between said analog strain gauge and said control unit; and
means to operably connect individually said DC power supply, said transformer driver circuits, said synchronous demodulator, and said calibration shunt to said control unit.

20. The analog strain gauge conditioning system of claim 19, wherein said synchronous demodulator comprises a synchronous rectifier.

21. The analog strain gauge conditioning system of claim 20, wherein said synchronous rectifier comprises four analog switches configured to operate in synchrony with said transformer driver.

22. The analog strain gauge conditioning system of claim 19, wherein said calibration shunt comprises:
a resistor operably connected to said analog strain gauge load cell; and
a relay operably disposed between said resistor and said control unit.

23. A method of monitoring a docking maneuver in a space environment in real time, comprising:
sensing a load applied to said analog strain gauge load cell comprising said analog strain gauge conditioning system during docking; and
conditioning said analog strain gauge signal via said conditioning system wherein said conditioned signal is a continuous representation of said strain gauge load during docking thereby monitoring the docking maneuver in real time.

24. The method of claim 23, wherein said strain gauge load cell is physically mounted in the space environment and said excitation and sense transformers independently interface with the space environment and a location protected from the space environment suitable for conditioning the analog strain gauge signal.
